(19) United States
(12) Patent Application Publication
(10) Pub. No.: US 2016/0135067 A1
(43) Pub. Date: May 12, 2016

(54) CALL DETAIL RECORD-BASED MULTIPLE NETWORK OPTIMIZATION

(71) Applicant: Cellmining Ltd., Caesarea (IL)

(72) Inventors: Shmuel MORAD, Hod-HaSharon (IL); Jose COHENCA, Natania (IL); Greg Giora SNIPPER, Caesarea (IL)

(21) Appl. No.: 14/600,282

(22) Filed: Jan. 20, 2015

Related U.S. Application Data
(60) Provisional application No. 62/077,978, filed on Nov. 11, 2014.

(51) Int. Cl. H04W 24/08; H04W 64/00

(52) U.S. Cl. CPC H04W 24/08; H04W 64/003; H04W 84/042

(57) ABSTRACT

According to some embodiments of the invention there is provided a method for evaluating a performance of a cellular radio network. The method comprises receiving two or more call detail records from a repository of a cellular radio network, wherein the cellular radio network comprises two or more directional sector antennas. The method comprises identifying two or more antenna pairs among the directional sector antennas, each one of the antenna pairs used to perform one of multiple subscriber calls documented in the call detail records. The method comprises calculating two or more sector pair usage parameters one for each of the antenna pairs according to an analysis of respective the subscriber calls. The method comprises analyzing the sector pair usage parameters to evaluate a performance of the cellular radio network.

### RELATED APPLICATION

This application claims the benefit of priority under 35 USC 119(e) of U.S. Provisional Patent Application No. 62/077,978 filed Nov. 11, 2014, the contents of which are incorporated herein by reference in their entirety.

### FIELD AND BACKGROUND OF THE INVENTION

The present invention, in some embodiments thereof, relates to cellular radio network optimization and, more specifically, but not exclusively, to cellular radio network optimization based on analysis of call detail records.

After many decades that cellular radio networks for mobile device communication have been in use, many generations and types of wireless cellular radio networks are in operation. As used herein, the term cellular radio network means a cellular and/or telecommunication network of radio devices and directional sector antennas used to perform voice and/or data communications from a mobile cellular device, such as a mobile phone, smart phone, tablet, laptop, and the like. These generations of networks have new frequency bands, higher data transfer rates, better network maintenance tools, and the like. For example, second generation wireless telephone technologies (2G) were launched in 1991 but are still used in many parts of the world. Examples of 2G networks are Time Division Multiple Access (TDMA)-based and Code Division Multiple Access (CDMA)-based networks, such as Global System for Mobile Communications (GSM), Interim Standard 95 (cdmaOne), and the like. Third generations of mobile telecommunications technologies (3G), such as Enhanced Data rates for GSM Evolution (EDGE), Universal Mobile Telecommunications System (UMTS), and the like, were introduced in 1998 and further increased the data transfer rates. Fourth generation network (4G) data rates allow new applications, such as high definition mobile television, and the like. For example, Long-Term Evolution (LTE) and Mobile Worldwide Interoperability for Microwave Access (mobile WiMAX) are 3G mobile communication networks. Multiple generations of cellular radio networks are in operation concurrently by a network operator, and cellular phones radios include these multiple technologies are used by subscribers. Infrastructure hardware components to support these networks, such as network devices, and transfer a cellular telephone conversation within and/or between networks have similarly evolved over the generations of cellular radio networks. When a subscriber is having a telephone conversation when moving, the cellular radio networks pass the call between directional sector antennas, base transceiver stations, and generations of networks so that the conversation is uninterrupted. As used herein, the term base station means a base transceiver station, a radio base station (RBS), a Node B in 3G Networks, an evolved Node B, and the like.

Multiple antennas are connected to each base station, each directional antenna covering a sector or a geographic cell. As used herein, the term sector means a directional antenna covering a geographical area. For example, a base station has three sectors each with a 120-degree arc of coverage from the base station. For example, a base station has six sectors each with a 60-degree arc of coverage from the base station. The base stations of geographically adjacent cells may be connected to a Radio Network Controller (RNC) and multiple RNCs may be connected to a network switching subsystem, such as one or more mobile switching centers (MSC). As used herein, the term adjacent means geographically adjacent such that two sector coverage areas are located next to each other, possibly with some overlap. As used herein, the term network device means a hardware infrastructure component of the cellular radio network, such as a directional antenna, a base station, a RNC, a MSC, an OSS, and the like. In some cellular radio networks, data communication is handled by separate hardware components from voice communications, such as a GSM network transferring data communication with a Serving General Packet Radio Service Support Node (SGSN). Operations Support Systems (OSS) are computerized systems that monitor and control the base stations, controllers, and switching centers.

Fourth generation cellular radio networks include self organizing and/or optimizing network (SON) technologies that provide automatic or semi-automatic functions to manage, configure, plan, optimize, control and repair cellular radio networks. For example, SON features include determining a dataset of automatic neighbor relationships used to link between network devices, such as base stations, RNCs, MSCs, and the like, for optimal cellular radio network performance. For example, SON features include self-configuration, self-optimization, and self-healing of a cellular radio network device, such as a base station, a RNC, a MSC, and the like. SON features may be incorporated into base stations, radio controllers, switching centers, the OSS, and like hardware components of the cellular radio network. Hardware probes operated by field engineers may perform at least some of the SON features.

### SUMMARY OF THE INVENTION

According to some embodiments of the invention there is provided a method for evaluating a performance of a cellular radio network. The method comprises receiving two or more call detail records from a repository of a cellular radio network, wherein the cellular radio network comprises two or more directional sector antennas. The method comprises identifying two or more antenna pairs among the directional sector antennas, each one of the antenna pairs used to perform one of multiple subscriber calls documented in the call detail records. The method comprises calculating two or more sector pair usage parameters one for each of the antenna pairs according to an analysis of respective the subscriber calls. The method comprises analyzing the sector pair usage parameters to evaluate a performance of the cellular radio network.

Optionally, the method further comprises receiving a configuration data from a operational system of the cellular radio network, wherein the configuration data comprises a geographical location for each of the directional sector antennas, and further comprises calculating a subscriber movement score for each of the antenna pairs based on the call detail records and the geographical locations.

Optionally, each of the call detail records comprises an antenna identification of one of the directional sector antennas, an initiating phone number, a receiving phone number, a start time stamp and an end time stamp.

Optionally, the subscriber calls are calculated by sorting the call detail records chronologically and wherein the sector pair usage parameters are calculated by counting the subscriber calls between corresponding pairs of the directional sector antennas.

Optionally, the method further comprises changing automatically a configuration data of the cellular radio network according to the performance, and configuring automatically the directional sector antennas according to the changed configuration data.

Optionally, the cellular radio network comprises two or more network devices, and further comprises changing automatically a configuration of one or more of the network devices according to the performance.

Optionally, the analyzing produces one or more change to a sector neighbor relations dataset used by two or more base stations of the cellular radio network for linking between some of the base stations, and wherein the one or more change is used to improve the performance.

Optionally, the analyzing produces one or more virtual drive test of one or more road of a region of the cellular radio network according to the call detail records and the directional sector antennas, wherein the one or more virtual drive test measures the performance of the cellular radio network along the one or more road.

Optionally, the analyzing produces one or more crossed cable score between two or more base stations of the cellular radio network based on the call detail records, and wherein the one or more crossed cable score is used to improve the performance.

Optionally, the analyzing produces one or more change to one or more cellular network code of one of the directional sector antennas based on the call detail records, and wherein the one or more change is used to improve the performance.

Optionally, the one or more cellular network code is any from the list of an analog code, a digital code, a scrambling code, a physical cell identity code, and a base station identity code.

Optionally, the analyzing produces one or more change to a frequency of one of the directional sector antennas based on the call detail records, and wherein the one or more change is used to improve the performance.

Optionally, the analyzing produces one or more change to a channel of one of the directional sector antennas based on the call detail records, and wherein the one or more change is used to improve the performance.

Optionally, the analyzing produces one or more change to any from the list of a Local Area Communication, a Routing Area Code, and Timing Advance Command of one of the directional sector antennas based on the call detail records, and wherein the one or more change is used to improve the performance.

Optionally, the analyzing produces one or more Low Quality Call value of one of the directional sector antennas based on the call detail records, and wherein the one or more Low Quality Call value is used to improve the performance.

Optionally, the cellular radio network is two or more networks from a group comprising a second generation cellular network, a third generation cellular network, and a fourth generation cellular network, and wherein the call detail records are combined for the networks.

Optionally, the repository is any repository attached to an infrastructure component of the cellular radio network, wherein the infrastructure component is any from the list of a Mobile Switching Center, a Serving General Packet Radio Service Support Node, a Billing System Database system, and a mediation tool system.

Optionally, the analyzing produces one or more power level change of one or more of the directional sector antennas based on the call detail records and one or more network key performance indicators (KPIs), wherein the KPIs indicate a sector utilization level, and the method further comprises changing automatically a power level according to respective the one or more power level change.

Optionally, the analyzing produces one or more antenna tilt angle change based on the call detail records, and the method further comprises changing automatically a power level of one or more of the directional sector antennas according to respective the one or more antenna tilt angle change.

Optionally, the one or more change is a deletion of one or more element of the sector neighbor relations dataset.

Optionally, the one or more change is an addition of one or more element of the sector neighbor relations dataset.

According to some embodiments of the invention there is provided a computer readable medium comprising computer executable instructions adapted to perform the method described herein.

Optionally, an operational support system reads computer readable medium and wherein the operational support system executes the computer executable instructions.

According to some embodiments of the invention there is provided an apparatus for optimizing a cellular radio network. The apparatus comprises one or more network interface. The apparatus comprises one or more user interface. The apparatus comprises one or more processing unit. The processing unit comprises processor instructions adapted to receive two or more call detail records from a repository of a cellular radio network using the one or more network interface, wherein the cellular radio network comprises two or more directional sector antennas. The processing unit comprises processor instructions adapted to identify two or more antenna pairs among the directional sector antennas, each one of the antenna pairs used to perform one of two or more subscriber calls documented in the call detail records. The processing unit comprises processor instructions adapted to calculate two or more sector pair usage parameters one for each of the antenna pairs according to an analysis of respective the subscriber calls. The processing unit comprises processor instructions adapted to analyze the sector pair usage parameters to evaluate a performance of the cellular radio network.

According to some embodiments of the invention there is provided a computer program product for optimizing a cellular radio network. The computer program product comprises a computer readable storage medium. The computer readable storage medium has stored thereon first program instructions executable by a processor to cause the processor to receive two or more call detail records from a repository of a cellular radio network, wherein the cellular radio network comprises two or more directional sector antennas. The computer readable storage medium has stored thereon second program instructions executable by a processor to cause the processor to identify two or more antenna pairs among the directional sector antennas, each one of the antenna pairs used to perform one of two or more subscriber calls documented in the call detail records. The computer readable storage medium has stored thereon third program instructions executable by a processor to cause the processor to calculate two or more sector pair usage parameters one for each of the antenna pairs according to an analysis of respective the subscriber calls. The computer readable storage medium has stored thereon fourth program instructions executable by a processor to cause the processor to analyze the sector pair usage parameters to evaluate a performance of the cellular radio network.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention may involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an apparatus to optimize a cellular radio network based on call detail records and network configuration data analysis, according to some embodiments of the invention;

FIG. 2 is a flowchart of a method to optimize a cellular radio network based on call detail records and sector analysis, according to some embodiments of the invention;

FIG. 3 is a flowchart of a method to calculate CDR-based sector usage scores, according to some embodiments of the invention;

FIG. 4 is a flowchart of a method to calculate CDR-based subscriber movement score, according to some embodiments of the invention;

FIG. 5 is a flowchart of a method to change an automatic neighbor relationships dataset of a cellular radio network, according to some embodiments of the invention; and

FIG. 6 is a flowchart of a method to update the tilt angle of a directional sector antenna based on call detail records, according to some embodiments of the invention.

### DESCRIPTION OF SPECIFIC EMBODIMENTS OF THE INVENTION

The present invention, in some embodiments thereof, relates to cellular radio network optimization and, more specifically, but not exclusively, to cellular radio network optimization based on analysis of call detail records.

Existing solutions for self-optimizing of cellular radio networks do not support 2G network analysis due to the complexity of the technology, such as the 2G protocols and messaging. Additionally, 2G networks have a variety of proprietary interfaces making the connection of hardware probe devices complicated or impossible.

In 3G networks, some optimization vendors connect a hardware probe device to the network device, such as a Node-B, RNC, MSC and the like, using a standard interface. The main drawback of this approach is that there are many such components in a network requiring high associated costs, such as the hardware cost of each probe, the costs of software and modules needed for each probe, the cost of sending an engineer to each site, and the like. For example, every probe devices costs about $70,000 and additional costs are needed for corresponding software and operation of the device. For example, a service technician or engineer must visit each site, such as a base station, to perform the analysis with the hardware probe connected directly to the component. A further complication for automatic network optimization of a central component in the network is that the higher the central component is in the network hierarchy, the less communication details for individual subscriber calls are available for analysis of network usage.

No existing solutions optimize multiple vendor components on multiple technology networks. For example, cellular radio network products, such as Nokia Megamon, Ericsson GPEH, Huawei CHR, and the like, provide built in probe devices that are limited to 3G network analysis and limited to the information available on the specific vendor's infrastructure components of a cellular radio network. For example, optimization vendors like Cisco (Intucel), Cellwize Amdocs (Celcite) support Ericson GPEH access 2G network data via OSS counters, which are statistical summaries and not granular enough to yield detailed and knowledgeable optimization decisions. For example, cellular equipment manufacturers sell OSS software that provides statistics on a 2G cellular radio network but this software is based on counters of summed data that do not have enough detail for high performance optimization.

According to some embodiments of the invention, the performance of a cellular radio network is monitored and optimized according to analysis of subscriber call activity. Call detail records (CDRs) are collected and analyzed together with network configuration data to identify patterns of usage, such as subscriber calls, between directional antennas by the mobile devices of the cellular radio network. These patterns of usage are calculated from hundreds of millions of daily subscriber voice calls and data flow CDRs that document the antennas used during the calls, and are used to generate score values representing actual subscriber usage of the cellular radio network. Based on the subscriber calls, a CDR-based sector pair usage score between sector pairs, such as beginning and end sectors of the call, and a CDR-based subscriber movement score between sector pairs are analyzed. The CDR-based sector pair usage score and subscriber movement score are used to evaluate the network performance and make changes to optimize the performance of the network according to the actual call activity on the network.

Embodiments of the invention trace the relationships between sectors and subscriber calls based on the amount of handovers between sectors during a subscriber call and/or during idle times, along with other call performance parameters. From the relationships between sectors and subscriber calls, embodiments of the invention compute optimization features, such as changes to a neighbor relationships dataset, duplicate frequencies between sectors, duplicate scrambling codes between sectors, antenna tilt and power consumption, virtual drive test, low call quality detection and the like.

Embodiments of the invention operate similarly to social GPS applications, such as Waze and the like, to evaluate and improve the performance of a cellular radio network. For example, the data used for optimization is subscriber call activity, such as crowd source data, and not only the engineered network maintenance infrastructure and/or components, such as statistical measures and/or counters.

The optimization features based on the CDRs allow optimization within and/or across 2G, 3G and 4G cellular radio network technologies. For example, neighbor relationship dataset changes are computed for sectors between a 2G and 4G networks.

Embodiments of the inventions receive network and/or component configuration data from an Operations Support Systems (OSS), such as counter values, network element configuration, network policy, network topology, sector geographical locations and the like.

According to some embodiments of the invention, there is provided an apparatus and a method for optimizing the performance of a cellular radio network in a certain cellular radio network region according to mobile device usage patterns calculated by an analysis of current CDR data and current network configuration data. CDRs for the certain cellular radio network region are received from one or more repositories of the network, for example a mobile switching center, mobility management entity, mediation software, billing system, and the like. Cellular radio network configuration data, such as directional antenna (sector) configuration data, base transceiver station data, radio network center data, and the like, are received from an operational support system (OSS) of the cellular radio network. For example, the hardware component data is configuration data, such as geographical location. For example, hardware component data is configuration data such as a link between two hardware components. For example, hardware component data is operational data such as transmission power history of a directional sector antenna.

The CDRs and component configuration data are analyzed by a module of a self-optimizing network (SON) apparatus to determine the mutual CDR-based usage score of actual use between each sector pairs. Additionally, a CDR-based subscriber movement score for calls placed by a subscriber while moving is calculated by the module, such as a call made from a moving vehicle. These two scores are used to analyze the network performance and perform changes to the network to optimize the performance according to the actual usage.

As the performance analysis and network changes are based on the CDRs, the optimization is independent of the network generation. For example, a network operator has a second generation, a third generation and a fourth generation cellular radio network operating in the same geographical region, and CDRs of these networks are combined to compute a performance analysis and perform network changes to optimize the usage between the networks.

Optionally, a SON apparatus performs a network change automatically by changing a configuration parameter of a cellular radio network. For example, the SON apparatus computes additions and/or deletions to a dataset of neighbor relationships between sectors and a neighbor relationship dataset is updated automatically by the SON apparatus by sending an extended hypertext language command to an OSS.

Optionally, a network change is performed semi-automatically. For example, when a network change is computed that cannot be performed automatically, a notification is sent to an operator to change a switch manually and subsequent to this, a further change is made automatically.

Optionally, a network change is performed manually. For example, when network change is computed that must be performed manually within the OSS, a notification is sent to an operator of the cellular radio network.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

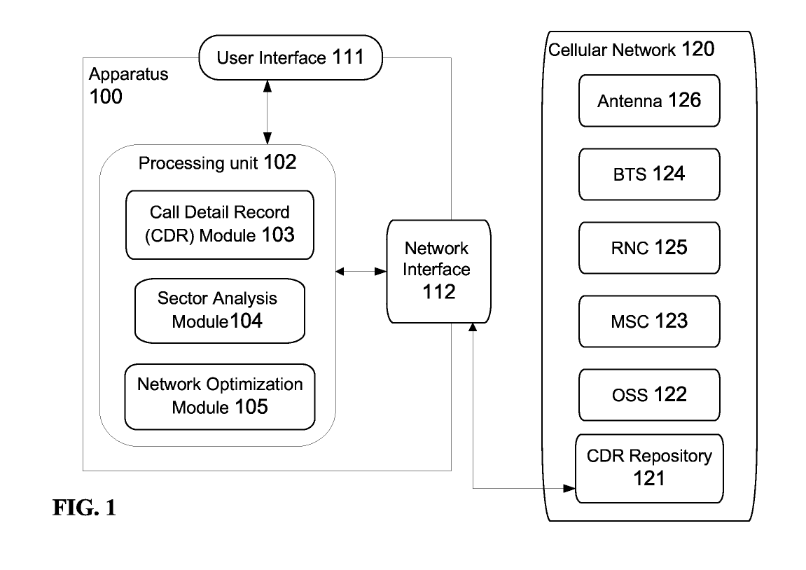

Reference is now made to FIG. 1, which is a schematic illustration of an apparatus 100 to optimize a cellular radio network based on CDRs and network configuration data analysis, according to some embodiments of the invention. A Call Detail Record (CDR) module 103 of a processing unit 102 receives multiple CDRs from one or more CDR repositories 121 of a cellular radio network 120 and cellular radio network configuration data from the OSS 122. The CDR module 103 identifies the CDRs associated with sectors and organizes the CDRs into subscriber calls sorted chronologically, where each group of CDRs belonging to the same subscriber call identifies the beginning and ending sectors of that call. As used herein, the term identify, correlate, organize, arrange and the like mean to determine a relationship between members of a group. As used herein, the term analyze means to perform an analysis, a computation, a calculation, a processing, and the like to determine a parameter value. The sector analysis module 104 of the processing unit 102 receives the sorted subscriber calls and cellular radio network configuration data from the CDR module 103. CDR-based sector pair usage scores are calculated by the sector analysis module 104 from the subscriber calls and sector data according to an analysis of the transfer of calls between sector pairs. CDR-based subscriber movement scores are computed according to an analysis of two or more calls from the same subscriber and the geographical locations of the beginning and ending sectors of each call. Each sector of the cellular radio network 120 corresponds to a directional sector antenna 126 that allows user equipment, such as a cellular phone and the like, to perform mobile communications, such as voice calls or data access to a network, in a geographical coverage area.

Using the CDR-based sector pair usage and subscriber movement scores, the network optimization module 105 computes cellular radio network performance values, and calculates changes to the cellular radio network configuration data and performs SON functions to improve the performance of the cellular radio network 120 based on the subscriber usage and CDRs. The cellular radio network performance values are sent to a user interface 111 for monitoring of the cellular radio network 120. The calculated changes to the cellular radio network configuration data may be performed by the network optimization module 105, a service engineer after receiving a notification on the user interface 111, or a combination thereof.

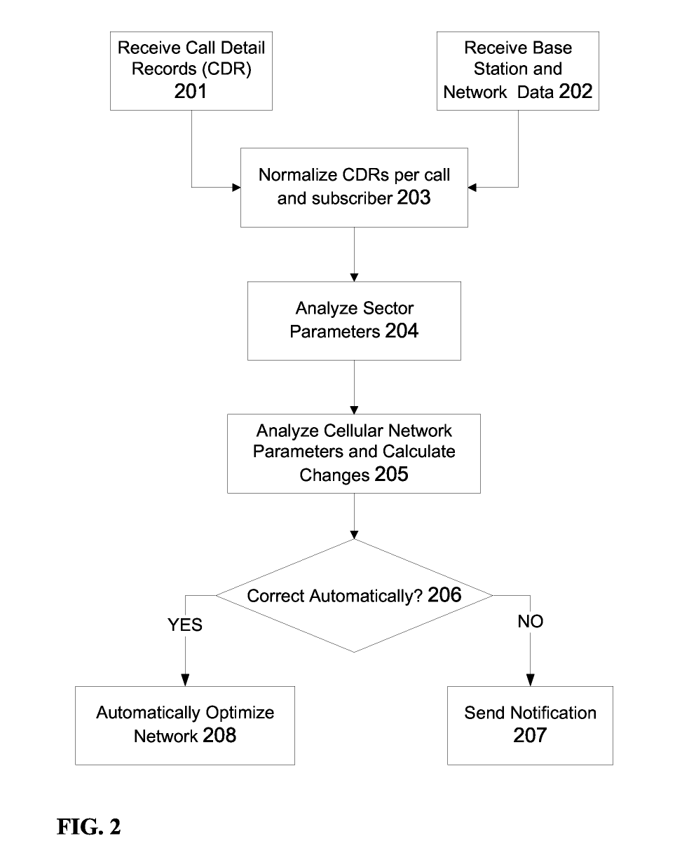

Reference is now made to FIG. 2, which is a flowchart of a method to optimize a cellular radio network based on call detail records and sector analysis, according to some embodiments of the invention. The CDRs and cellular radio network component data is received 201 and 202 respectively by a CDR module 103 of a processing unit 102 of an apparatus 100. The CDR module 103 normalizes 203 the CDRs into documented subscriber calls, and sends the subscriber calls to the sector analysis module 104. The CDRs may identify data relating to subscriber call and directional sector antenna used to perform the call, such as an antenna identification of one of the directional sector antennas, an initiating phone number, a receiving phone number, a start time stamp, an end time stamp, call termination reason, and the like. A call termination reason may be a network drop, a normal subscriber hang-up, and the like. The sector analysis module 104 calculates 204 sector scores, such as CDR-based sector pair usage score, CDR-based subscriber movement score, CDR-based dropped calls rate and the like. The CDR-based scores and cellular radio network configuration data are transferred by the sector analysis module 104 to the network optimization module 105. The network optimization module 105 analyzes 205 performance parameters, such as subscriber call handovers and the like, and calculates network configuration changes to the cellular radio network component configurations that may improve the performance of the cellular radio network 120, such as the automatic neighbor relationship dataset changes and the like described herein. The network configurations changes may be performed automatically 206 by the network optimization module 105 to optimize 208 the cellular radio network 120. When the network configuration changes require an input and/or action by a network operator, the network optimization module 105 sends 207 a notification to a user interface 111. For example, when a network configuration parameter needs to be changed on a component that does not have a computerized maintenance and/or control interface for automatic changes, such as switching a faulty cable, broken network interface card, and the like, the change may be performed at least in part manually by a engineer and/or technician.

Optionally, CDR analysis and/or network optimization may be implemented daily and automatic neighbor relationships (ANR) calculations and load balancing may be performed by a network optimization module 105 at a time interval between 15 to 30 minutes.

Optionally, call detail records are retrieved by a CDR module 103 from a component of the mobile network, such as a CDR repository 121. For example, in 2G cellular radio networks voice call detail records are provided from a repository connected to a mobile switching center 123. For example, in 3G cellular radio networks data call detail records for data communications are provided from a serving general packet radio service support node (SGSN).

Optionally, cellular radio network configuration data are provided by an integration component of the mobile network. For example, base station and/or sector geographical location data is provided from an OSS 122. For example, base station 124 and RNC 125 relationships, sector frequencies, scrambling codes, adjacent sectors dataset and the like are provided from an OSS 122. For example, sector and/or site key performance indicators (KPIs) are provided from an OSS 122. As used herein, the term site means a geographical location of a base station, a radio network controller, and the like. For example, network configuration policy is determined initially from an adjacent sector policy file provided by the mobile operator. For example, network frequency usage policy is validated during operation against actual adjacent sector frequencies.

Optionally, CDRs from one or more cellular radio networks are combined. For example, CDRs documenting a subscriber call are retrieved from two or more MSCs 123 on different cellular radio networks when a subscriber call has moved between a 2G cellular radio network to a 3G cellular radio network during the call.

Optionally, a subscriber may be transferred from a 2G cellular radio network to a 3G or 4G cellular radio network for services, for example to play a ringtone.

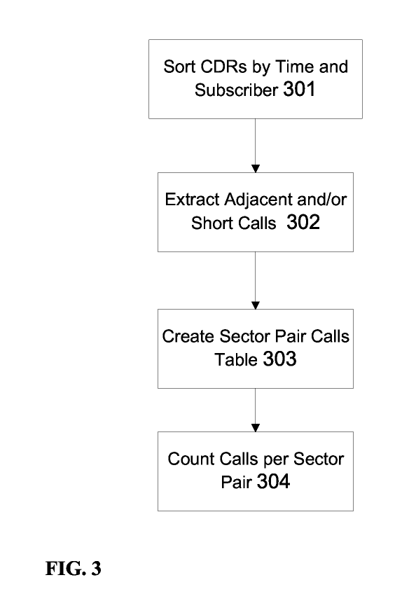

Reference is now made to FIG. 3, which is flowchart of a method to calculate CDR-based sector pair usage scores, according to some embodiments of the invention. To calculate the CDR-based sector pair usage scores, the CDR module 103 sorts 301 the CDRs by time and subscriber by correlating the CDRs. Adjacent and/or short calls are extracted 302 from the sorted CDRs by the CDR module 103. For example, call sequences from the same subscriber with less than 60 seconds difference between the calls are extracted. For example, a short call is a call with duration shorter than 60 seconds is extracted. The extracted calls are related by beginning and ending sectors, such as directional sector antennas, and organized in a sector pair calls dataset created 303 by the sector analysis module 104. For example, a short call less than 60 seconds starts at sector A and ends at sector B. For example, a sequence of calls starts at sector A and ends at sector B. For example, a sequence of calls comprises a first call that ends at sector A and a last call that begins at sector B. The sector analysis module 104 counts 304 the calls per sector pair, such as sector A to sector B, to calculate the CDR-based sector pair usage score between sector pairs. Thus, a dataset is generated with the CDR-based usage scores between each combination of sector pairs based on the actual cellular radio network usage. For example, the CDR-based sector pair usage score between sectors A and B is different from the CDR-based sector pair usage score between sectors B and A.

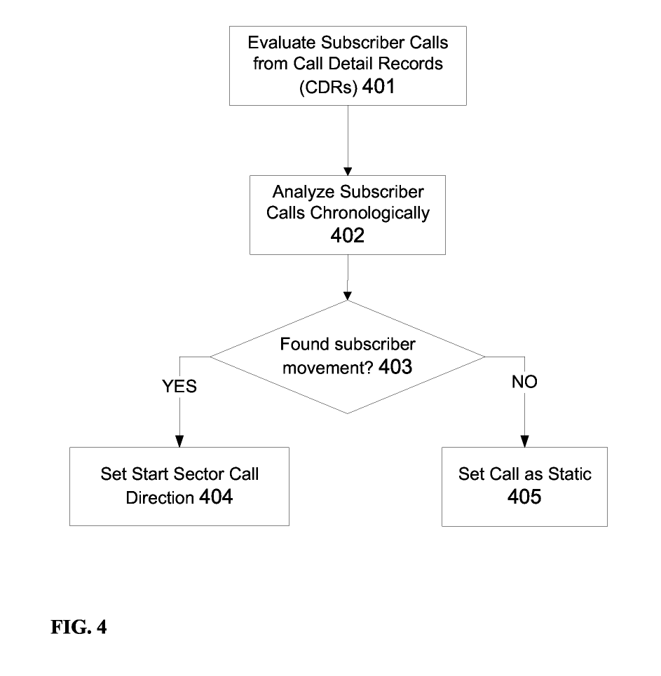

Reference is now made to FIG. 4, which is flowchart of a method to calculate CDR-based subscriber movement scores, according to some embodiments of the invention. Subscriber calls are evaluated 401 from the documenting CDRs by a CDR module 103. Subscriber calls are analyzed 402 chronologically by the sector analysis module 104, such as two call of the same subscriber within a time window. For example, the sector analysis module 104 analysis of each call stops at the first start/end call sector that meets the criteria. For example, a previous or next call within 30 minutes and with different non-adjacent start and end sectors indicates a movement of the subscriber. When the analysis results indicate a subscriber movement 403 of a call, the CDR-based subscriber movement score is calculated 404 based on the geographical locations of the base stations 124 and/or sectors as an orientation value between the beginning and ending sectors of the call by the sector analysis module 104. Adjacent end sectors may be located in the proximity to the evaluated start sector and the orientation of subscriber movement may not be explicit, while a non-adjacent end sector indicates that the subscriber may have left the region around the evaluated start sector.

The cellular radio network performance values are used to monitor and/or improve the network performance based on the CDRs, network configuration data, and/or actual subscriber call usage of the cellular radio network.

The following paragraphs describe the analysis details of cellular radio network performance values and implementation of SON features, analyzed and implemented by the front end interface 101, based on CDR data and/or scores calculated thereof. Each analyzed value and/or implemented feature may use one or more input data for analysis of the performance and/or implementation of the feature, such as the CDR data, sector pair usage scores, subscriber movement score, geographical sector locations, configuration data, and/or the like. The performance values may be updated by the network optimization module 105 at predefined time intervals as needed for system performance, and notified to an operator using a dashboard display sent to a user interface 111. For example, the sector pair usage score is updated daily based on adding the CDRs form the previous 24 hours to the CDR data. For example, load balancing automatic neighbor relationship dataset update is performed every 15 minutes based on the CDRs from the last two hours to dynamically adjust the power of each directional sector antenna to actual real-time subscriber call usage.

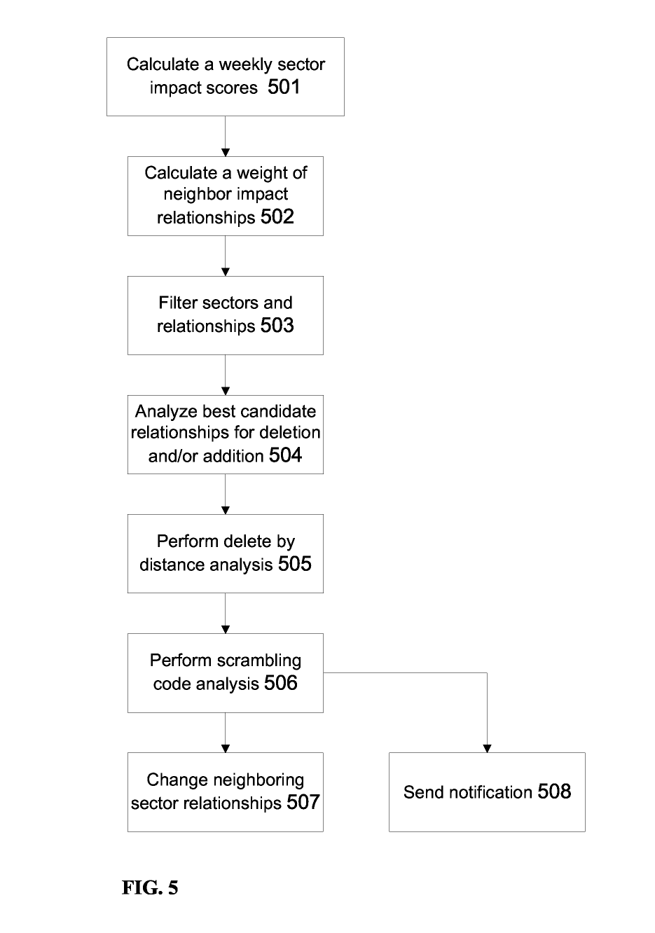

Optionally, an automatic neighbor relationship dataset is modified according to a CDR-based sector pair usage score and/or CDR data by a network optimization module 105 during the action of analyze cellular radio network parameters 205 to support an improvement of the cellular radio network performance. Reference is now made to FIG. 5, which is flowchart of a method to change an automatic neighbor relationships dataset of a cellular radio network, according to some embodiments of the invention. The network optimization module 105 calculates 501 a weekly CDR-based sector pair usage score by computing the daily CDR-based sector pair usage score average over the last week. Weights of neighbor CDR-based usage relationships are calculated 502 by the network optimization module 105 according to co-located sectors and the number of dropped calls. For example, co-locating the CDR-based sector pair usage score summaries extends the summary to consider implicit usage assumptions about sector pairs of GSM, UMTS, LTE and the like cellular radio network technologies. For example, per sector pair A and B with an CDR-based sector pair usage score above a threshold and of a given technology, such as 2G, 3G, 4G and the like, the network optimization module 105 checks when there are corresponding sectors C and D with a similar orientation to A and B, respectively, with lesser CDR-based sector pair usage score and of a different network technology. When such a corresponding sector pair exists, the network optimization module 105 may apply the CDR-based sector pair usage score of sector pair A to B to sector pair C to D, such as by using an averaging function, median function, extrapolating function, statistical function, and the like. The criteria for a similar orientation definition may depend on operator policy of a range of orientations that are considered similar. In such an example, the sector pair A and B is considered to be co-located with sector pair C and D.

Optionally, an automatic neighbor relationship dataset may accumulate entries as a first-in-first-out stack. Sectors and relationships may be filtered 503 by the network optimization module 105. For example, sectors that are blacklisted for changes are filtered from the candidate relationship list by the network optimization module 105. For example, existing neighbor relationships are filtered from candidate additions by the network optimization module 105. For example, sector pairs with a CDR-based sector pair usage score below a threshold are filtered by the network optimization module 105. The network optimization module 105 analyzes 504 best candidate relationships for deletion and/or addition, performs 505 an additional delete by distance analysis, and performs 506 a scrambling code analysis. The network optimization module 105 changes 507 automatically the neighbor sector relationships determined by the previous analysis steps, or sends 508 a notification to system engineer using a user interface 111. For example, a manual task performed by an engineer is to make a decision when potential sector neighbor relationships do not cross a specified threshold of CDR-based sector pair usage score. For example, when sector neighbor relationships have a CDR-based sector pair usage score within a specified low range a notification is sent to an engineer.

Optionally, candidate neighbor relationships for addition and/or deletion may be selected within the constraints of a network policy received from an OSS 122. For example, adjacent sectors on same base station 124 with the same frequency are considered candidates for adding a neighbor relationship. Candidate neighbor relationship may be marked for deletion based on a maximum allowed neighbor relationship deletions per sector per optimization interval by a network optimization module 105. For example, a neighbor relationship may be marked for deletion because it has a CDR-based sector pair usage score of zero. For example, a neighbor relationship may be marked for deletion because it has no handovers according to an OSS counter value. For example, a neighbor relationship may be marked for deletion because it has CDR-based sector pair usage scores of zero in both orientations between two sectors and has no handovers according to an OSS counter value. Since CDR-based sector pair usage scores include handoffs between the sectors while the mobile device is in idle mode, such as between calls during a call sequence, the CDR-based sector pair usage scores include handovers that are not counted by the OSS handover count.

A renew neighboring operation is a relationship link delete and add back operation. For example, a neighbor relationship is renewed when there are no handovers between the sectors according to an OSS counter, the sector pair has a non-zero CDR-based sector pair usage score and the relationship is not in a marked for deletion.

Deletion of candidate neighbor relationship may be performed once a week by the network optimization module 105.

Optionally, a missing RNC link analysis is performed by the network optimization module 105 according to CDR data during the action of analyze cellular radio network parameters 205 to support an improvement of the cellular radio network performance. A call may be disconnected when a subscriber moves from a sector managed by a first RNC 125 to a sector managed by second RNC not linked to the first RNC. The number of calls transferred between unlinked RNCs is a measurement of the missing RNC links, and a notification may be sent to a user interface 111.

Optionally, a crossed cable analysis based on CDR-based sector pair usage scores and/or CDR data by the network optimization module 105 during the action of analyze cellular radio network parameters 205 to support an improvement of the cellular radio network performance. For each sector where at least 70% of the calls are static, for example calls with identical start and end call sectors, the network optimization module 105 checks when there is any other sector within the coverage area of that sector. For example, check when within a range of orientations between plus or minus 35 degrees relative to the orientation of the evaluated sector's directional sector antenna 126, and within 4 kilometers of the antenna base station 124. Sectors with a directional sector antenna orientation directed towards a region that is not covered by the mobile operator are removed by the network optimization module 105, such as an international border or a geographical barrier like a lake or mountain where cellular radio network service is not provided. The calculation by the network optimization module 105 of a location that is on the border of the coverage region is as follows. For these sectors, count all the base stations with a sector having a non-zero CDR-based sector pair usage score with the evaluated sector, and count only base stations that have a CDR-based sector pair usage score in an arc along the orientation of the directional sector antenna 126, referred to a total site count and an arc site count respectively. For example, when the directional sector antenna 126 has a 60-degree arc of coverage, then network optimization module 105 evaluates all the base stations in a 70-degree arc that is in the same orientation. For example, when an evaluated sector has a directional sector antenna 126 with a 120-degree arc of coverage, the network optimization module 105 evaluates all the base stations in a 130-degree arc that is in the same orientation as the evaluated sector directional sector antenna. The ratio between the arc site count to the total site count is a crossed cable score and the crossed cable score is sent to the user interface 111. Based on threshold of the crossed cable score the network optimization module 105 may automatically determine when there are crossed cables. For example, when the crossed cable score is greater than or equal to 0.8 there are no crossed cables. For example, when the crossed cable score is less than 0.2 and there are at least three sectors with an antenna orientation opposite to the direction of the antenna orientation of the evaluated sector, there are crossed cables of the evaluated sector. For each base station 124 where there are two or more sectors with crossed cables indication, the base station 124 may have crossed cables. Based on a threshold time value of a base station 124 having a crossed cable indication, a notification may be sent by the network optimization module 105 to a user interface of a maintenance system. For example, a network optimization module 105 counts the number of consecutive days since the crossed cables indication started and when the count is over a threshold, such as seven days, a notification is sent to a user interface 111 for the maintenance engineer to take a respective action.

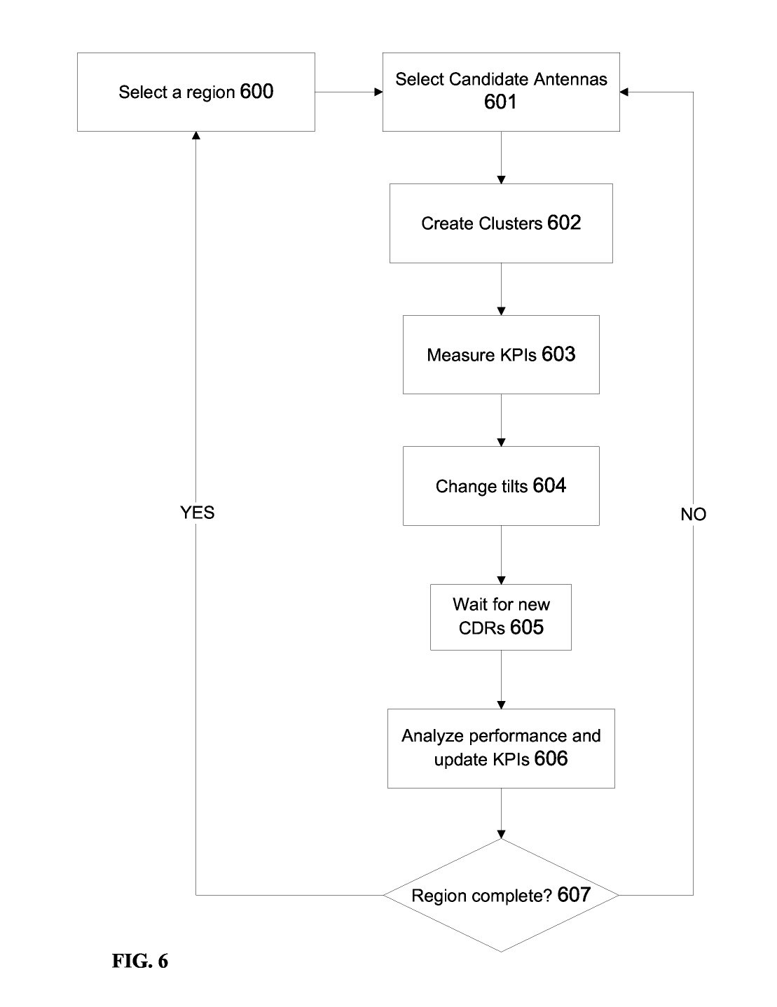

Optionally, directional antenna tilt angles are optimized using CDR-based sector pair usage score and/or CDR data by a network optimization module 105 of a front end interface 101 during the action of analyze cellular radio network parameters 205 to support an improvement of the cellular radio network performance. Reference is now made to FIG. 6, which is a flowchart of a method to update the tilt angle of a directional antenna based on call detail records, according to some embodiments of the invention. Once a region for antenna tilt angle optimization is selected 600, candidate antennas 126, such as sectors, are selected 601 within that region. Of these candidates, the network optimization module 105 creates 602 geographical clusters of candidates and only one candidate is changed per geographical cluster so that the changes do not affect each other. Key performance indicators (KPIs) are measured 603 for a time period before the antenna tilt change, such as during a one week time period. The tilt angles of the selected candidate directional antennas are changed 604 either electronically by the front end interface 101 or manually by a field technician, after the engineer has received a notification on a user interface 111. The network optimization module 105 waits 605 for a time period, such as a week, to collect new CDR data, analyzes 606 the new network performance values, such as CDR-based sector pair usage and subscriber movement scores, after the change, and updates the KPIs. Based on the comparison of performance values and KPIs before and after the change, the antenna tilt changes are evaluated by the network optimization module 105 to determine the effect of the antenna tilt change on network performance. The method is repeated for other sectors and clusters based on the antenna tilt changes completed and the remaining candidates in each geographical cluster, until the region is complete 607.

In selecting 600 a region to perform the antenna tilt angle optimization, the widest possible region may be selected. The time period over which KPIs are measured may be selected to prevent daily fluctuations of the KPIs from affecting the optimization decisions made by the network optimization module 105. Additionally, when an antenna tilt angle change is made to one sector the CDR-based sector pair usage and subscriber movement scores may change for the sectors of the region.

Optionally, selection 601 of the candidate sectors for an antenna tilt change may be performed according to CDR-based sector pair usage scores, sector antenna orientation, CDR-based subscriber movement score, handover history between sectors, and the like. The network optimization module 105 may filter the candidate sectors according to a sectors blacklist. Antenna tilt change candidates may be selected by the network optimization module 105 using CDR-based sector pair usage circle groups that are located according to the orientations and/or distances between sectors. A first circle group is sectors with high CDR-based impacts scores and located very close to the evaluated site and/or sector. A second circle group is sectors with high CDR-based impacts scores located in a distance greater than the average distance of the adjacent sectors of the site, but less than a threshold distance. A third circle group is sectors with high CDR-based impacts scores located further away from the sites the second circle group threshold. The detection of a third circle group may be a strong indication for sector pilot pollution, such as overshooting, which may be corrected by a tilt reduction.

The network optimization module 105 performs cluster creation 602 by selecting candidate sectors from the antenna tilt change candidates list, such that there may be a geographical separation between sectors. A separation between sectors by creating clusters when changing the tile angle allows the network performance and the performance of individual sectors to be evaluated by the network optimization module 105 without interactions between the affects of the tilt angle changes. For example, choosing two sectors in a cluster causes a degradation of the network performance but since two changes were made in the cluster it is difficult to determine which change cause the degradation. For example, an antenna tilt angle change by the network optimization module 105 affects the proximity of the sectors that were yet to be analyzed and new gaps are formed between the sectors. Performing changes by sector clusters enables addition of new sectors while maintaining the gap between the remaining sectors.

The analysis of antenna tilt angle changes compares subscriber related KPIs during a long time period following the antenna tilt angle change on the sector in the cluster, such as a 5 week analysis time period. For example, at the end of each week after the change by the network optimization module 105 the subscriber KPI values are compared with the previous week.

Based on the KPI changes between analysis time periods, the network optimization module 105 may determine that the antenna tilt angle change may be continued for evaluation, returned to previous angle, or accepted. A dataset for each change may be used by the network optimization module 105 to track the decision following each analysis time period, such as a row is added for each antenna tilt angle change and a column for each analysis time period. Each dataset element may contain an index for a start antenna tilt angle change, continue antenna tilt angle change evaluation, return to previous angle, accept new antenna tilt angle, and the like. Optionally, a continue antenna tilt angle change evaluation by the network optimization module 105 may include an adjustment of the antenna tilt angle by a small amount, such as one degree. Following a return or accepted index the sector may be removed by the network optimization module 105 from the candidate list and from the geographical cluster.

For example, a region has eight candidate sectors for an antenna tilt angle change, one each for separate geographical clusters. After the end of the first analysis time period, analysis of the KPI changes by the network optimization module 105 for each sector from before and after the change determine that three changes are accepted, three changes are continued for evaluation, and two changes are restored to the previous antenna tilt angle. Of the three sectors for continued evaluation by the network optimization module 105, two include an adjustment of the antenna tilt change by one degree. Subsequent to this, four new sectors from the candidate list may be chosen based on the available geographical clusters and the antenna tilt angles changed for these four new sectors. After the end of the second analysis time period, the KPI analysis and resulting actions by the network optimization module 105 for each continuing and new sector are replicated. The process is repeated until all the sectors of the candidate list have been evaluated.

The KPI calculations may be performed by the network optimization module 105 based on CDR data of individual subscribers, unlike previous methods of relying on counters. The KPI analysis may consider indicators calculated from the CDR data such as dropped calls rate, repeat calls, out of service rate, CDR-based sector pair usage scores, CDR-based subscriber movement scores, and the like. For example, subscribers are associated to a sector when each subscriber has performed at least two daily calls during a 5 day period involving the evaluated sector. For each subscriber, three KPI values may be calculated by the network optimization module 105, considering calls involving either the evaluated sector or any of impacted sectors of the evaluated sector.

For example, a first subscriber is a natural association subscriber and all calls made by the subscriber involve the evaluated sector and the first and second circle groups from the evaluated sector. For example, a second subscriber is a non-natural association subscriber and has calls made by the subscriber involving the third circle group from the evaluated sector. Following an antenna tilt angle change of the evaluated sector, the KPI value changes for the two subscribers are evaluated. The first subscriber's KPI values are in improved in the 1st circle group, yet the KPI values need to be evaluated at the second circle group as well. The second subscriber is at high risk of service degradation, since before the antenna tilt angle change the subscriber performed calls involving the evaluated sector and remote third circle group sectors of the region. There may be two options for the second subscriber. The first option is that the KPI values are improved after the antenna tilt angle change since the subscriber is then performing calls on the natural sites at the subscriber's location, without using the evaluated sector. The second option is that the third circle group sectors are not able to serve the subscriber sufficiently, some or all of the KPI values of the evaluated sector for this subscriber may be degraded. Following the antenna tilt angle change the second subscriber may be more out of service, may have more repeat calls, may have more call failures, and the like. When both subscribers' KPIs are improved after an antenna tilt angle change, it implies that the antenna tilt angle change was effective and improved the network performance.

When antenna tilt angle changes are based on counters, an antenna tilt change may result in a reduction of call traffic on the evaluated sector and an increase in call traffic on the adjacent sectors. Identifying the sectors where the call traffic moved to is difficult based on counters as every sector may receive a small amount of call traffic that is hard to trace. In addition, the counter represents an overall level of call traffic, impacted by various network changes, and not necessary related the antenna tilt angle change performed.

Optionally, a sector frequency and/or code duplications analysis is performed by the network optimization module 105 based on CDR data. The weekly CDR-based sector pair usage score summary is merged with the sector neighbor data dataset by the network optimization module 105. The network optimization module 105 calculates a paired duplication indication by finding two sectors with the same frequency and code where the CDR-based sector pair usage scores are over a threshold or are the sectors are neighbored. The network optimization module 105 calculates a triple duplication indication by finding two sectors having the same frequency plus code as the sector being evaluated, such as sector X, and CDR-based sector pair usage scores with sector X over a threshold. For each paired or triple duplication indication, the network optimization module 105 finds and assigns a clear frequency and/or code for one of the sectors, based on a calculation of the best clear frequency and/or code, such as a frequency and/or code that reduce interference with the adjacent sectors. For example, on a GSM network the network optimization module 105 finds a clear Base Station Identity Code (BSIC) and finds a clear frequency. For example, in a Universal Mobile Telecommunications System (UMTS) or Long-Term Evolution (LTE) network the network optimization module 105 finds a clear scrambling/Physical Call Identity (PCI) code and/or Random-access channel (RACH) for sectors with associated paired duplication indications. For example, in a UMTS or LTE network the network optimization module 105 finds a clear code/channel for sectors with associated triple duplication indications and CDR-based sector pair usage scores is above a threshold, or deletes the link between the sectors when the CDR-based sector pair usage scores are below a threshold. For example, when a sector pair of a triple duplication has a low CDR-based sector pair usage score and are neighbored, the network optimization module 105 marks the pair's relationship for deletion. For example, when a sector pair of a triple duplication has a high CDR-based sector pair usage score and the sector pair is adjacent, the network optimization module 105 finds a clear scrambling/PCI code or clear channel.

Optionally, the CDR-based sector pair usage score is used for clean frequency, channel, and scrambling code analysis by the network optimization module 105 during the action of analyze cellular network parameters 205 to support an improvement of the cellular radio network performance. The CDR-based sector pair usage score is summarized by the network optimization module 105 over an analysis time period, such as one week, and merged with the sector geographical and neighbor relationship dataset. Network policy blacklist of sectors, frequencies, codes, such as BSIC and/or scrambling codes, are taken into account by the network optimization module 105 on the merged sector data. A level one relation between a sector pair, such as A and B, is assigned by the network optimization module 105 when the CDR-based sector pair usage score is above a threshold or the sectors are adjacent sectors, when the sectors are linked in the neighbor relationship dataset, and/or when the CDR-based sector pair usage scores are asymmetrical. As used herein, the term linked means that there exists an entry in the neighbor relationship dataset between two sectors. When the sector pair is neighbored, the CDR-based sector pair usage score may be multiplied by a factor by the network optimization module 105. A level two relation between sectors is assigned by the network optimization module 105 to a sector triplet, such as X, A, and B, when the CDR-based sector pair usage scores between one sector and the other two are above a threshold, any two sectors of the triplet are linked in the neighbor relationships dataset, and/or when two sectors of the triplet have the same frequency and/or channel. When either the sector pair X and A or the sector pair X and B are not neighbors, than the network optimization module 105 considers their CDR-based sector pair usage score as the level two relation score. Otherwise, the network optimization module 105 considers the higher CDR-based sector pair usage score between the two pairs and adds an offset.

The level one and two relations are merged by the network optimization module 105 by removing same frequency, code, and/or channel sector pairs with level one relation, adding an offset to neighbored sectors with level one relation. For every merged sector pair with different CDR-based sector pair usage scores, the merged pair receives the highest score from the network optimization module 105. A list of all sectors in the network is created by the network optimization module 105 and for each sector the available frequencies and/or codes are indicated, different from the current frequency and/or code of that sector, and the minimal distance to another sector with the same frequency, channel, and/or code is indicated. For every sector pair in the merged list, alternative clear frequencies and/or codes are based on evaluating all sectors that are linked, have CDR-based impact, or are adjacent to either sector of the pair. For either sector of the pair, each alternative clear frequencies and/or code is by the network optimization module 105 ranked by applying a weight that is the addition of the CDR-based sector pair usage score with the most remote evaluated sector and the distance between either sectors of the pair and the evaluated sector. For every sector pair in the merged list, the network optimization module 105 chooses the lowest weight rank and rule out the second lowest ranked weight. For example, in a GSM network the calculation is performed by the network optimization module 105 to determine a broadcast control channel, such as a frequency channel, for selecting a frequency.

Optionally, CDR-based sector pair usage scores are recorded, KPIs are recorded, and network configuration data is monitored for changes by the network optimization module 105 during the action of analyze cellular network parameters 205 to support an improvement of the cellular network performance. When a change is detected by the network optimization module 105 that has negative effect on CDR-based sector pair usage scores and KPI, a notification is sent to an operator. Optionally, network configuration data is restored by the network optimization module 105 immediately to a previous value based on a CDR-based sector pair usage score and KPI criteria. Optionally, network configuration data is restored later by the network optimization module 105 according to a network schedule to a previous value based on a CDR-based sector pair usage score and KPI criteria. Optionally, the restored parameters are specific per mobile operator, per network technology, and per network components.

Optionally, a CDR-based sector pair usage score is used by the network optimization module 105 to perform a load balance analysis of sectors during the action of analyze cellular network parameters 205 to support an improvement of the cellular radio network performance. For example, sector power is reduced by the network optimization module 105 in over utilized sectors with low data throughput, such as throughput is less than 1 megabyte per second, or low sector accessibility, such as less than 80% and power over 80%. For example, an over utilized sector power is adjusted, and/or an existing neighbor relation is deleted, by the network optimization module 105 when an adjacent site has sectors with high CDR-based sector pair usage with the over utilized sector, and which are not loaded, such that their power is less than 50%. It is important to note that the Load Balancing analysis may be performed every 15-60 minutes, and therefore if the over utilization was caused by a temporary event that created a crowded network, then when the crowed network clears, the network optimization module 105 may restore the original power parameters level and/or a deleted neighbor relation. In addition, the network optimization module 105 applies a self-learning mechanism that detects a repeat over utilization pattern and deduces that the modification of power parameters and/or the removal of a neighbor relation should be retained or a regular basis.

Optionally, a virtual test drive analysis by the network optimization module 105 is performed according to CDR-based sector pair usage scores, such as analysis of target roads predefined in a cellular operational support system, during the action of analyze cellular network parameters 205 to support an improvement of the cellular radio network performance. For example, all sectors that are up to 3 kilometers in distance from the target road are selected by the network optimization module 105, and the closest sectors on each side of the road are defined as base sectors. From the example base sectors, the sectors with directional antennas 126 pointing at the road and/or street are selected by the network optimization module 105. The pointing base sectors are located in the CDR-based subscriber movement score dataset. The CDR-based sector pair usage scores and dropped call counts in the direction of the road, such as within a 45 degree angle from the pointing direction of the road and/or street are selected. Sectors that have a CDR-based sector pair usage score over a threshold with the left and right base sectors, in the direction of the road/street, are identified as external sectors by the network optimization module 105. The overall dropped calls and CDR-based sector pair usage scores between the base and external sectors are calculated by the network optimization module 105 for each point along the road. The calculated results are a list of high runner roads, streets and/or segments therein that may yield a list of high runner sectors. For example, high runner road segments have a high dropped call rate at that point along the road. For example, the sum of all road segment scores is a measure for the road as a whole.

Optionally, a calculation by the network optimization module 105 of subscriber home and/or office sector locations is based on CDR data during the action of analyze cellular network parameters 205 to support an improvement of the cellular radio network performance. For CDRs made during normal business hours each business day, collect the sectors of these calls and remove sectors that have not appeared in the daily pool for a pool time period, such as a two week period, to define the office sectors for each subscriber. For CDRs made during the evening, collect the sectors of these calls and remove sectors that have not appeared in the daily pool for a pool time period, such as a two week period, to define the home sectors for each subscriber.

Optionally, a delete by distance analysis is performed by the network optimization module 105 according to a CDR-based sector pair usage scores and network configuration data during the action of analyze cellular network parameters 205 to support an improvement of the cellular radio network performance. The network optimization module 105 creates a blacklist of neighbor relationships where the impacts of a sector has coordinates which are different from the configuration coordinates of the site that either of the CDR-based sector pair usage sectors reside on. The network optimization module 105 selects neighbor relationships with a distance between sectors above a threshold, such as a threshold of at least 20 kilometers. When these sector pairs have a zero CDR-based sector pair usage score and are not in the blacklist, they are candidates for relationship deletion by the network optimization module 105.

Optionally, a re-homing analysis is performed by the network optimization module 105 according to CDR-based sector pair usage scores during the action of analyze cellular network parameters 205 to support an improvement of the cellular radio network performance. For example, a change of base stations and/or sectors association with a RNC and/or base station controller is determined by the network optimization module 105. The CDR-based sector pair usage scores are used by the network optimization module 105 to analyze missing neighbor relationships as described herein, optimize base station and/or sector parameter default values, and the like.

Optionally, a dimensioning analysis is performed by the network optimization module 105 according to CDR data during the action of analyze cellular network parameters 205 to support an improvement of the cellular radio network performance. For example, when a subscriber call is transferred between two or more sectors, for each subscriber call the network optimization module 105 identifies the Local Area Communication (LAC), the Routing Area Code, or the Timing Advance Command (TAC), depending on the network technology such as 2G, 3G or 4G respectively, of the starting sector, denoted sector A, the end sector, denoted sector B, and the starting sector of the next consecutive call of the same subscriber, denoted sector C. The LAC, RAC or TAC of sectors A, B and C are compared and a dimensioning sum is calculated for each different LAC, RAC, or TAC between sector A and sectors B or C. When the dimensioning sum greater than a threshold, sector A is associated with the same LAC, RAC or TAC that sector B or C is associated with.

Optionally, a low quality calls analysis is performed by the network optimization module 105 according to CDR data during the action of analyze cellular network parameters 205 to support an improvement of the cellular radio network performance. For example, CDR data is analyzed by the network optimization module 105 to identify consecutive calls between a subscriber phone number and a second phone number. For each subscriber phone number, the network optimization module 105 counts the total low quality calls (TLQC) as the number of consecutive calls where the time difference between the two calls is below a threshold, such as 120 seconds, one of the call durations is below a second threshold, such as 10 seconds, and one of the calls ended normally.

When the second phone number has a TLQC number above a threshold, such as 50, the network optimization module 105 adds the second phone number to a low quality analysis blacklist. When the subscriber phone number has TLQC numbers above a threshold for multiple different second phone numbers, the network optimization module 105 adds the subscriber phone number to the low quality analysis blacklist. Phone numbers on the low quality analysis blacklist may be ignored in the calculation of TLQC numbers.

When the end sector of the first call has a dominant subscriber, such as over 40% of the calls involving the dominant subscriber, the network optimization module 105 disqualifies the sector from the flowing results analysis and corrective actions.

Optionally, the network optimization module 105 calculates a low quality rate value (LQR) as the TLQC divided by the total number of calls. For example, the network optimization module 105 calculates the LQR per subscriber, the LQR per device model, the average ELQ number per sector, the LQR per base station, the LQR per RNC, the LQR per network, and/or the like, and may send the collated averages to a user interface for review by an operator. When the LQR per network infrastructure hardware component are above a threshold, a malfunction may be present in the component. For example, an E1 line may be identified with the low quality calls and the operator is sent a notification to service and/or replace it by the network optimization module 105. For example, a sector may be identified with a high LQR and the operator is sent a notification to reboot the sector by the network optimization module 105. For example, a base station may be identified with a high LQR and the operator is sent a notification to replace the baseband card by the network optimization module 105. For example, a controller may be identified with a high LQR and the operator is sent a notification to check the controller configuration by the network optimization module 105. For example, a RNC may be identified with a high LQR and the operator is sent a notification to check the RNC RAC configuration by the network optimization module 105.

Subsequent to the network optimization module 105 computing parameter values and changes, the changes may be performed automatically, semi-automatically, or manually. The calculated configuration changes to improve the network performance may be performed automatically on the components of the cellular network 120 by the network optimization module 105. For example, the network optimization module 105 modifies the configurations of the base stations (BTS) 124, the radio network controllers (RNC) 125, base station controller (BSC) 123, the eNodeB, and the like using a network interface 112 to the OSS 122. Optionally, the calculated configuration changes to improve the network performance may be performed semi-automatically by the network optimization module 105 sending a notification to a service engineer through a user interface to perform a first manual change, and one or more changes performed automatically by the network optimization module 105. Optionally, the calculated configuration changes to improve the network performance may be performed manually by the network optimization module 105 sending a notification to a service engineer through a user interface to perform one or more manual changes. The calculated changes or a notification thereabout may be sent to a user interface 111 to notify an a service engineer to perform at least some of the changes manually using the network interface 112 to the OSS 122 of the apparatus, a computer terminal connected to the network, a handheld hardware probe connected to a component of the cellular radio network, and the like.

The benefits of embodiments of the inventions allow mobile operators to maintain a network while reducing the operational cost of the network infrastructure and the cost of the engineering work to maintain the legacy networks, such as 2G, 3G and 4G cellular radio networks. Additional benefits of embodiments of the invention include customer call experience trending and analysis.

For example, embodiments of the invention generate return on investment for mobile operators monitoring and/or reducing the drop call ratio, maintaining high quality calls and continuous data connections, while supporting very little or no growth of cellular infrastructure investment, reduction in field technician workload, reduction in Engineer workload, reduction of lab tests for devices in service locations, a reduction in handset replacements, and the like. For example, embodiments of the invention allow maintaining and/or optimizing 2G, 3G and 4G networks, thereby reducing engineering time needed for manual handling of 2G, 3G and 4G network optimizations. For example, embodiments of the invention perform closed loop SON features that reduce the need to manually validate optimization changes and/or network performance after such changes. For example, embodiments of the inventions enables mobile operators to proactively mitigate high runners, such as subscribers with high dropped-call rate and low call quality, by using retention messaging, device compatibility suggestions, sale of a repeater device, adding the subscribers to a blacklist, such as ignoring the CDRs produced by the subscriber, and the like. For example, embodiments of the invention enable mobile operators to detect crossed cables based on network behavior, eliminating the trial-and-error methods currently used, in order to correct crossed cable problems that are almost impossible to detect and/or track. For example, embodiments of the invention enable mobile operators to detect malfunctioning network interface slots or baseband cards, to restart a miss-configured sector, or to re-configure an RNC/BSC according to the rate of detected low quality calls of an individual sector or on a group of sectors. For example, embodiments of the invention enable mobile operators to set a higher priority to missing neighbor relations for sectors that are located on main roads. It is important to note that the SON feature analysis is highly affected by errors in the network configuration. Errors may be caused by numerous reasons such as crossed cables, miss-configured sectors, miss-configured other network elements, an individual subscriber making calls from a problematic location, road, and/or device model, and the like. Therefore, the ability to clear the noise by eliminating the root causes, and the ability to prioritize based on subscriber activity based considerations is key for a successful and most effective SON.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant cellular network hardware components will be developed and the scope of the term network component is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for evaluating a performance of a cellular radio network, comprising:
receiving a plurality of call detail records from a repository of a cellular radio network, wherein said cellular radio network comprises a plurality of directional sector antennas;
identifying a plurality of antenna pairs among said plurality of directional sector antennas, each one of said plurality of antenna pairs used to perform one of a plurality of subscriber calls documented in said plurality of call detail records;
calculating a plurality of sector pair usage parameters one for each of said plurality of antenna pairs according to an analysis of respective said plurality of subscriber calls; and
analyzing said plurality of sector pair usage parameters to evaluate a performance of said cellular radio network.

2. The method of claim 1, further comprising receiving a configuration data from a operational system of said cellular radio network, wherein said configuration data comprises a geographical location for each of said plurality of directional sector antennas, and further comprising calculating a subscriber movement score for each of said plurality of antenna pairs based on said plurality of call detail records and said geographical locations.

3. The method of claim 1, wherein each of said plurality of call detail records comprises an antenna identification of one of said plurality of directional sector antennas, an initiating phone number, a receiving phone number, a start time stamp and an end time stamp.

4. The method of claim 1, wherein said plurality of subscriber calls are calculated by sorting said plurality of call detail records chronologically and wherein said plurality of sector pair usage parameters are calculated by counting said plurality of subscriber calls between corresponding pairs of said plurality of directional sector antennas.

5. The method of claim 1, further comprising changing automatically a configuration data of said cellular radio network according to said performance, and configuring automatically said plurality of directional sector antennas according to said changed configuration data.

6. The method of claim 1, wherein said cellular radio network comprises a plurality of network devices, and further comprising changing automatically a configuration of at least one of said plurality of network devices according to said performance.

7. The method of claim 1, wherein said analyzing produces at least one change to a sector neighbor relations dataset used by a plurality of base stations of said cellular radio network for linking between some of said plurality of base stations, and wherein said at least one change is used to improve said performance.

8. The method of claim 1, wherein said analyzing produces at least one virtual drive test of at least one road of a region of said cellular radio network according to said plurality of call detail records and said plurality of directional sector antennas, wherein said at least one virtual drive test measures said performance of said cellular radio network along said at least one road.

9. The method of claim 1, wherein said analyzing produces at least one crossed cable score between a plurality of base stations of said cellular radio network based on said plurality of call detail records, and wherein said at least one crossed cable score is used to improve said performance.

10. The method of claim 1, wherein said analyzing produces at least one change to at least one cellular network code of one of said plurality of directional sector antennas based on said plurality of call detail records, and wherein said at least one change is used to improve said performance.

11. The method of claim 10, wherein said at least one cellular network code is any from the list of an analog code, a digital code, a scrambling code, a physical cell identity code, and a base station identity code.

12. The method of claim 1, wherein said analyzing produces at least one change to a frequency of one of said plurality of directional sector antennas based on said plurality of call detail records, and wherein said at least one change is used to improve said performance.

13. The method of claim 1, wherein said analyzing produces at least one change to a channel of one of said plurality of directional sector antennas based on said plurality of call detail records, and wherein said at least one change is used to improve said performance.

14. The method of claim 1, wherein said analyzing produces at least one change to any from the list of a Local Area Communication, a Routing Area Code, and Timing Advance Command of one of said plurality of directional sector antennas based on said plurality of call detail records, and wherein said at least one change is used to improve said performance.

15. The method of claim 1, wherein said analyzing produces at least one Low Quality Call value of one of said plurality of directional sector antennas based on said plurality of call detail records, and wherein said at least one Low Quality Call value is used to improve said performance.

16. The method of claim 1, wherein said cellular radio network is a plurality of networks from a group comprising a second generation cellular network, a third generation cellular network, and a fourth generation cellular network, and wherein said plurality of call detail records are combined for said plurality of networks.

17. The method of claim 1, wherein said repository is any repository attached to an infrastructure component of said cellular radio network, wherein said infrastructure component is any from the list of a Mobile Switching Center, a Serving General Packet Radio Service Support Node, a Billing System Database system, and a mediation tool system.

18. The method of claim 1, wherein said analyzing produces at least one power level change of at least one of said plurality of directional sector antennas based on said call detail records and at least one network key performance indicators (KPIs), wherein said KPIs indicate a sector utilization level, and said method further comprises changing automatically a power level according to respective said at least one power level change.

19. The method of claim 1, wherein said analyzing produces at least one antenna tilt angle change based on said call detail records, and said method further comprises changing automatically a power level of at least one of said plurality of directional sector antennas according to respective said at least one antenna tilt angle change.

20. The method of claim 7, wherein said at least one change is a deletion of at least one element of said sector neighbor relations dataset.

21. The method of claim 7, wherein said at least one change is an addition of at least one element of said sector neighbor relations dataset.

22. A computer readable medium comprising computer executable instructions adapted to perform the method of claim 1.

23. The method of claim 22, wherein an operational support system reads computer readable medium and wherein said operational support system executes said computer executable instructions.

24. An apparatus for optimizing a cellular radio network, comprising:
at least one network interface;
at least one user interface; and
at least one processing unit comprising instructions adapted to:
receive a plurality of call detail records from a repository of a cellular radio network using said at least one network interface, wherein said cellular radio network comprises a plurality of directional sector antennas,
identify a plurality of antenna pairs among said plurality of directional sector antennas, each one of said plurality of antenna pairs used to perform one of a plurality of subscriber calls documented in said plurality of call detail records,
calculate a plurality of sector pair usage parameters one for each of said plurality of antenna pairs according to an analysis of respective said plurality of subscriber calls, and
analyze said plurality of sector pair usage parameters to evaluate a performance of said cellular radio network.

25. A computer program product for optimizing a cellular radio network, said computer program product comprising:
a computer readable storage medium having thereon:
first program instructions executable by a processor to cause said processor to receive a plurality of call detail records from a repository of a cellular radio network, wherein said cellular radio network comprises a plurality of directional sector antennas;
second program instructions executable by a processor to cause said processor to identify a plurality of antenna pairs among said plurality of directional sector antennas, each one of said plurality of antenna pairs used to perform one of a plurality of subscriber calls documented in said plurality of call detail records;
third program instructions executable by a processor to cause said processor to calculate a plurality of sector pair usage parameters one for each of said plurality of antenna pairs according to an analysis of respective said plurality of subscriber calls; and
fourth program instructions executable by a processor to cause said processor to analyze said plurality of sector pair usage parameters to evaluate a performance of said cellular radio network.
